(19) United States
(12) Patent Application Publication
(10) Pub. No.: US 2014/0063224 A1
(43) Pub. Date: Mar. 6, 2014

(54) IMAGE-PICKUP OPTICAL SYSTEM, IMAGE-PICKUP APPARATUS, AND IMAGE-PICKUP SYSTEM

(71) Applicant: CANON KABUSHIKI KAISHA, Tokyo (JP)

(72) Inventor: Masayuki Suzuki, Utsunomiya-shi (JP)

(73) Assignee: CANON KABUSHIKI KAISHA, Tokyo (JP)

(21) Appl. No.: 13/971,925

(22) Filed: Aug. 21, 2013

(30) Foreign Application Priority Data
Aug. 30, 2012 (JP) 2012-190612

(51) Int. Cl. H04N 7/18

(52) U.S. Cl. CPC H04N 7/18
USPC 348/79

(57) ABSTRACT

An image-pickup optical system includes a primary imaging optical system configured to form an image of an object, a secondary imaging optical system configured to re-form an image of the object, and a driver configured to drive an optical element included in the secondary imaging optical system and to change an aberration.

### BACKGROUND OF THE INVENTION

1. Field of the Invention

The present invention relates to an image-pickup optical system, an image-pickup apparatus, and an image-pickup system, configured to capture a microscopic image of a sample (specimen).

2. Description of the Related Art

In a microscopic system configured to capture a microscopic image of a sample, the sample is mounted, on the microscope, as a prepared slide held by a transparent member (cover glass) arranged on a slide glass. As a high resolution scheme in a wide field of view is promoted, a depth of focus reduces and focusing becomes difficult. As a result, focusing upon the entire sample surface (or surface along with it) becomes difficult due to the uneven thicknesses of the sample and the cover glass and the undulation of the surface shape.

Japanese Patent Laid-Open No. (“JP”) 2010-48841 proposes an objective lens configured to correct a spherical aberration by rotating a correction ring in accordance with a thickness error of the cover glass of the sample, and by moving a partial lens in an optical axis direction. JP 2011-95685 proposes a microscopic system configured to correct a spherical aberration by automatically moving a lens in an optical axis direction. JP 2011-209573 proposes a method for detecting an undulation of a sample and for providing focusing.

Each of the above patent documents cannot correct an aberration in an image-pickup area when the sample has an undulation, and it is insufficient to properly correct an aberration throughout a wide image-pickup area. This correction requires a small configuration for a miniaturization of the microscope.

### SUMMARY OF THE INVENTION

The present invention provides an image-pickup optical system, image-pickup apparatus, and image-pickup system configured to correct an aberration throughout a wide image-pickup area with a small configuration.

An image-pickup optical system according to the present invention includes a primary imaging optical system configured to form an image of an object, a secondary imaging optical system configured to re-form an image of the object, and a driver configured to drive an optical element included in the secondary imaging optical system and to change an aberration.

Further features of the present invention will become apparent from the following description of exemplary embodiments with reference to the attached drawings.

### BRIEF DESCRIPTION OF THE DRAWINGS

FIG. 1 is a block diagram of a microscopic system according to a first embodiment of the present invention.

FIG. 2 is a block diagram of a microscopic system according to a second embodiment of the present invention.

FIG. 3 is a block diagram of a microscopic system according to a third embodiment of the present invention.

FIG. 4 is a block diagram of a microscopic system according to a fourth embodiment of the present invention.

FIG. 5 is a block diagram of a microscopic system according to a fifth embodiment of the present invention.

### DESCRIPTION OF THE EMBODIMENTS

A description will now be given of embodiments according to the present invention.

### First Embodiment

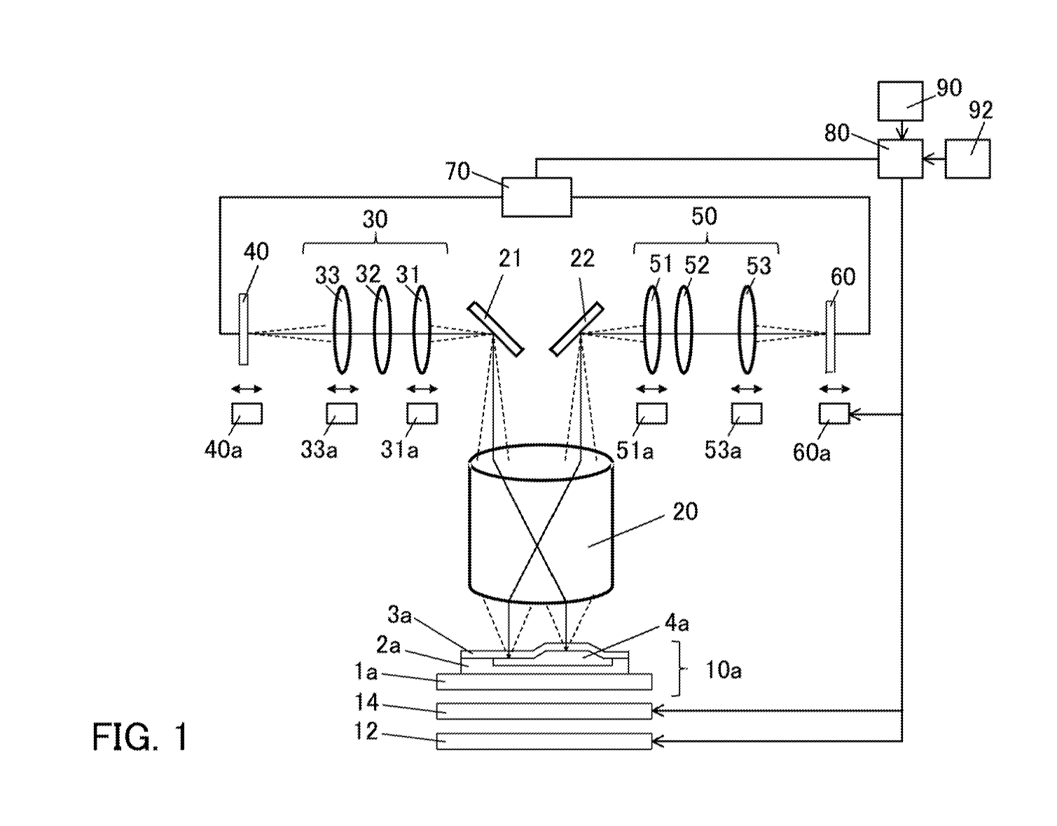

FIG. 1 is a block diagram of a microscopic system (image-pickup system) according to the first embodiment. The microscopic system includes an image-pickup apparatus and a measurement unit 92. The image-pickup apparatus captures a microscopic image of a sample, such as a human tissue, and the measurement unit 92 measures (or estimates) a surface shape (swell) of the sample. The measurement unit 92 may measure an aberration caused by a thickness of a cover glass or a slide glass and an undulation of the sample. The controller 80 obtains a measurement result from the measurement unit 92.

The image-pickup apparatus includes a light source 12, an illumination optical system 14, a prepared slide 10a, an image-pickup optical system, image sensors 40, 60, an image processor 70, a controller 80, and an operation unit 90. The image-pickup system includes a primary imaging optical system 20, a driver, mirrors (optical path deflectors) 21 and 22, and secondary imaging optical systems 30, 50.

The prepared slide (sample, object) 10a includes a slide glass 1a, a filler 2a, a cover glass 3a, and a sample 4a. The prepared slide 10a is arranged at or near the object plane of the primary imaging optical system 20. The thickness of the sample 4a housed in the prepared slide 10a scatters according to locations, and thus the cover glass 3a on the prepared slide surface is curved according to locations.

The illumination optical system 14 illuminates the prepared slide 10a mounted on a stage (not illustrated) configured to move in three directions and rotate around each axis, using light from the light source 12. In this embodiment, the light source 12 and the illumination optical system 14 are arranged under the prepared slide 10a, but their positions are not limited. In other words, the light source 12 and the illumination optical system 14 are arranged on the side of the cover glass 3a, and the primary imaging optical system 20 may be arranged on the side of the slide glass 1a. Alternatively, the light source 12, the illumination optical system 14, and the primary imaging optical system 20 on the side of the slide glass 1a may be arranged for the epi-illumination.

The primary imaging optical system 20 is an enlargement system, and forms an enlarged image of the sample (specimen) 4a. The primary imaging optical system 20 is a high resolution object lens having a wide field of view and illustrated as a dioptric system in FIG. 1. The primary imaging optical system 20 may be, but not limited to, a catadioptric coaxial optical system having a high numerical aperture (“NA”).

The mirrors 21 and 22 are arranged at or near the image plane positions of the primary imaging optical system 20, and configured to divide the image plane area of the primary imaging optical system 20 into two and to reflect and deflect the optical path to the left side and the right side, respectively. The mirrors 21 and 22 deflect the optical path, reduce the mechanical interference of the optical system, and provide the miniaturization. The mirrors can enable the necessary image plane area to be selected. The secondary imaging optical system 30 is arranged on the left side of the mirror 21, and the secondary imaging optical system 50 is arranged on the right side of the mirror 22. The “division into two” may not necessarily be two half areas having no overlaps. For example, due to the mechanical interference between the mirrors 21 and 22, the area of combining images reflected by both mirrors may be smaller than the image plane area.

The secondary imaging optical system 30 re-forms an enlarged image (light from the image plane of the primary imaging optical system 20) reflected by the mirror 21 onto the image sensor 40, and includes the lenses 31 to 33. The secondary imaging optical system 50 re-forms an enlarged image reflected by the mirror 22 onto the image sensor 60, and includes the lenses 51 to 53. The image sensors 40 and 60 are arranged at or near image planes of the secondary imaging optical systems 30 and 50, and each of them includes a photoelectric conversion element, such as a CCD or a CMOS, configured to photoelectrically convert an optical image. Each of the secondary imaging optical system 30 and 50 includes the same type of optical element arranged in the same order in the corresponding optical path.

The lenses (first lenses) 31 and 33 are configured to move (drive) in the optical axis direction of the image-pickup optical system by the drivers 31a and 33a, thereby changing the spherical aberration. The lenses (first lenses) 51 and 53 are configured to move (drive) in the optical axis direction of the image-pickup optical system by the drivers 51a and 53a, thereby changing the spherical aberration. The image sensors 40 and 60 can drive in the optical axis directions by the drivers 40a and 60a, and can correct defocus positions. The driver can use a well-known driving unit, such as a stepping motor, and a VCM.

The number of mirrors, imaging optical systems, and image sensors is plural (two) but it may be one, three or more. For example, the image plane area may be divided into four, six, and nine. Capturing a wide field of view of better imaging performance is available by increasing the dividing number of the image plane area of the primary imaging optical system. In addition, the number of lenses of the second imaging optical system is not limited.

Since the secondary imaging optical systems 30 and 50 are generally smaller than the primary imaging optical system 20, the image-pickup apparatus in which the movable optical element and the driver are provided in the secondary imaging optical system can be smaller than the image-pickup apparatus in which the movable optical element and the driver are provided in the primary imaging optical system. In changing the magnification, the optical element of the secondary imaging optical system may be exchanged.

In operation, the light source 12 and the illumination optical system 14 illuminate the prepared slide 10a, and the light flux emitted from the sample 4a passes the primary imaging optical system 20, and forms the enlarged image near the mirrors 21 and 22. The left area of the enlarged image formed by the primary imaging optical system 20 is reflected by the mirror 21, passes the secondary imaging optical system 30, and re-forms an image on the image sensor 40 arranged at or near the image plane of the secondary imaging optical system 30. The right area of the enlarged image formed by the primary imaging optical system 20 is reflected by the mirror 22, passes the secondary imaging optical system 50, and re-forms an image on the image sensor 60 arranged at or near the image plane of the secondary imaging optical system 50.

Since the sample 4a has an undulation, the object distance from the primary imaging optical system 20 to the sample 4a is different according to locations. Hence, a spherical aberration occurs which is different according to an observation location of the sample 4a in the initial state. This spherical aberration cannot be corrected simply by focusing, and the imaging performance deteriorates.

Accordingly, the spherical aberration of the image formed on the image sensor 40 is corrected by moving the lenses 31 and 33 in the optical axis direction. A defocus position is corrected by moving the image sensor in the optical axis direction. The spherical aberration of the image formed on the image sensor 60 is corrected by moving the lenses 51 and 53 in the optical axis direction. The defocus portion can be corrected by moving the image sensor 60 in the optical axis direction. This embodiment can make moving amounts of the lenses 31 and 33 different from those of the lenses 51 and 53. In addition, the moving amounts of the image sensors 40 and 60 can be made different from each other, and the object distance is different between the left and the right of the prepared slide 10a.

The controller 80 controls an operation of each part of the microscopic system, and includes a processor (microcomputer). For example, the controller 80 determines moving amounts (driving amounts) of the lenses 31, 33, 51, and 53 and the image sensors 40 and 60 by the drivers based upon the measurement result of the measurement unit 92. Alternatively, the controller 80 may determine the moving amount based upon the data input via the operating unit 90 by the user.

The measurement unit 92 may use an image-pickup optical system configured to capture the whole tissue in a wide range (although the image may have a low resolution). The size of the observation object contained in the sample can be calculated by a general approach, such as a binarization and a contour detection, using a brightness distribution of the sample image. As the measurement method of the surface shape, the reflected light may be measured or the interferometer may be used, such as an optical distance measuring method using an applied triangulation disclosed in JP 6-11341 and a method for measuring a difference of a distance of a laser beam reflected on a glass interface surface using a confocal optical system disclosed in JP 2005-98833. The measurement unit 92 serves to measure a thickness of the cover glass 3a using a laser interferometer.

If a combination of areas divided by the mirrors 21 and 22 is smaller than the entire area of the image plane, the stage mounted on the prepared slide 10a is driven and images are captured again. The analogue signals (electric signals) from the image sensors 40 and 60 are converted into digital signals via the A/D converters (not illustrated). A variety of types of image processor 70 are applied to the digital signals, and one image is synthesized and stored in the memory (storage unit) (not illustrated).

This embodiment can capture an image with a good imaging performance in a wide field of view and with a small configuration.

### Second Embodiment

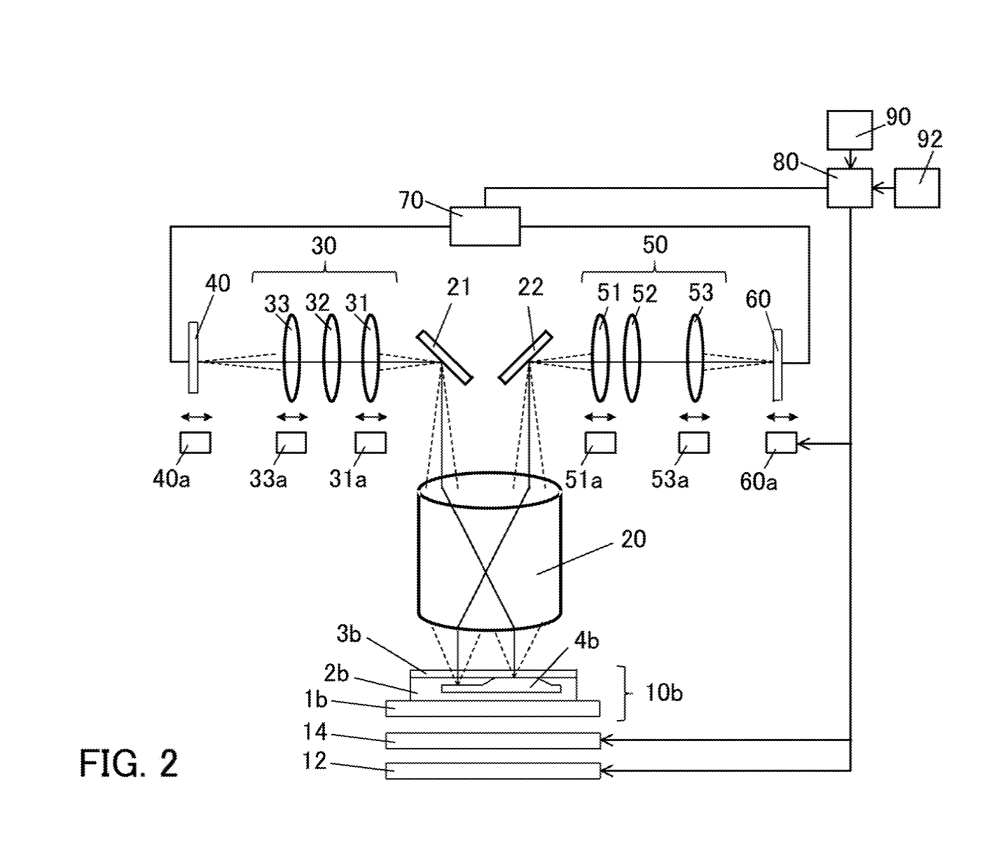

FIG. 2 is a block diagram of a microscopic system according to a second embodiment. Those elements in FIG. 2, which are corresponding elements in FIG. 1, are designated by the same reference numerals. The configuration of the microscopic system of FIG. 2 is the same as that of the microscopic system of FIG. 1 except for the prepared slide.

In FIG. 2, reference numeral 1b denotes a slide glass, reference numeral 2b denotes a filler, reference numeral 3b denotes a cover glass, and reference numeral 4b denotes a sample. The slide glass 1b to the sample 4b constitute the prepared slide 10b. The prepared slide 10b is arranged at or near the object plane position of the primary imaging optical system 20. The thickness of the sample 4b scatters according to locations. The cover glass 3b on the prepared slide surface is maintained plane, but a distance from the cover glass 3b to the sample 4b is different according to the locations. The spherical aberration occurs which is different according to observation locations of the sample 4b in the initial state, and the imaging performance deteriorates.

Accordingly, similar to the first embodiment, the spherical aberrations of the image formed on the image sensors 40 and 60 are corrected by moving the lenses 31, 33, 51, and 53 in the optical axis direction. In addition, the defocus position is corrected by moving the image sensors 40 and 60 in the optical axis direction. When the distance from the cover glass 3b to the sample 4b is different between the left and right sides of the prepared slide 10b as illustrated in FIG. 2, driving amounts of the lenses in the secondary imaging optical system and the image sensor are different between the left side and the right side.

This embodiment can capture an image with a good imaging performance in a wide field of view and with a small configuration.

### Third Embodiment

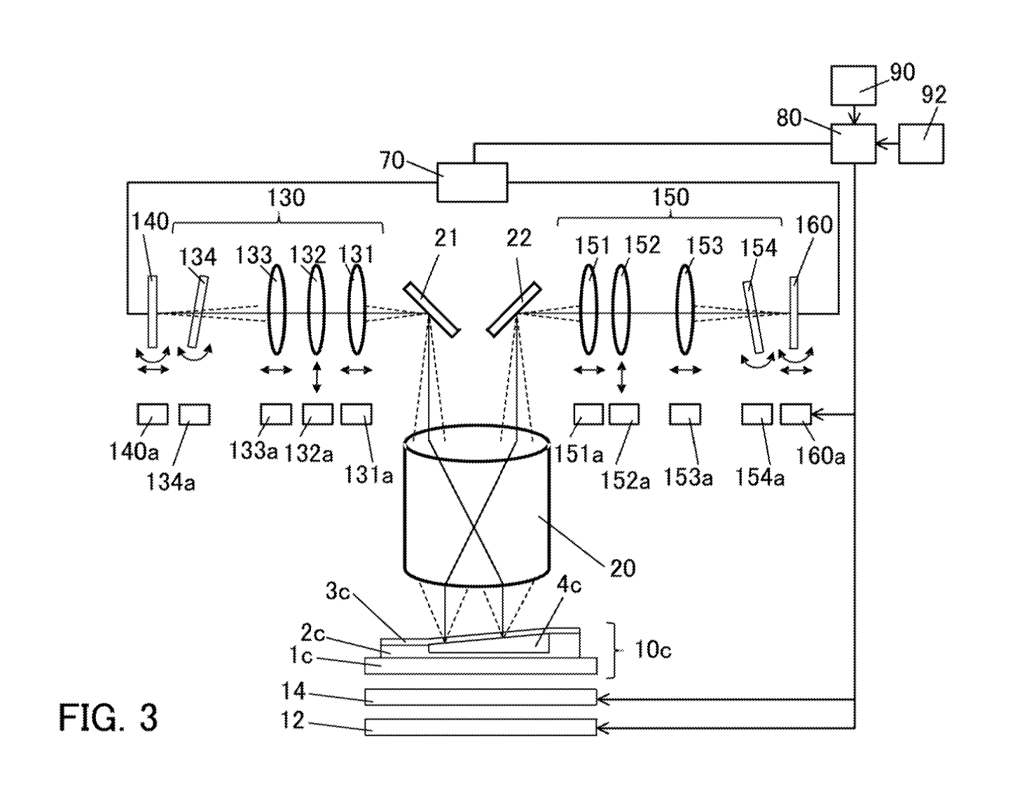

FIG. 3 is a block diagram of a microscopic system according to a third embodiment. Those elements in FIG. 3, which are corresponding elements in FIG. 1, are designated by the same reference numerals. The configuration of the microscopic system of FIG. 3 is the same as that of the microscopic system of FIG. 1 except for the prepared slide, the secondary imaging optical system, and the image sensor.

Reference numerals 130 and 150 denote secondary imaging optical systems, reference numerals 131 to 133 and 151 to 153 denote lenses, reference numerals 134 and 154 denote plane-parallel plates, and reference numerals 140 and 160 denote image sensors arranged at or near the image plane positions of the secondary imaging optical systems. Reference numeral 1c denotes a slide glass, reference numeral 2c denotes a filler, reference numeral 3c denotes a cover glass, and reference numeral 4c denotes a sample. The slide glass 1c to the sample 4c constitute the prepared slide 10c.

The prepared slide 10c is arranged at or near the object plane position of the primary imaging optical system. Since the thickness of the sample 4c scatters in a slope shape according to locations, as illustrated in FIG. 3, the cover glass 3c of the prepared slide surface inclines.

The second imaging optical system 130 is arranged on the left side of the mirror 21, and the left side of the image formed by the primary imaging optical system 20 is re-formed on the image sensor 140. The second imaging optical system 150 is arranged on the right side of the mirror 22, and the right side of the image formed by the primary imaging optical system 20 is re-formed on the image sensor 160.

The lenses (first lenses) 131, 133, 151 and 153 are configured to move in the optical axis direction of the image-pickup optical system by the drivers 131a, 133a, 151a, and 153a and thereby to change the spherical aberrations. The lens (second lens) 132 is configured to move in the direction perpendicular to the optical axis by the driver 132a, and can change a coma on the field center (on the optical axis) of the secondary imaging optical system 130. Similarly, the lens (second lens) 152 is configured to move in the direction perpendicular to the optical axis by the driver 152a, and can change a coma on the field center of the secondary imaging optical system 150. The plane-parallel plate 134 is configured to rotate or incline around an axis perpendicular to the optical axis by the driver 134a, and thereby can change the astigmatism on the field center (on the optical axis) of the secondary imaging optical system 130. The plane-parallel plate 154 is configured to rotate or incline around an axis perpendicular to the optical axis by the driver 154a, and thereby can change the astigmatism on the field center of the secondary imaging optical system 150. This embodiment can simultaneously correct the spherical aberration, coma, and astigmatism.

The image sensors 140 and 160 are configured to move in the optical axis direction by the drivers 140a and 160a, and can correct defocus positions. The image sensors 140 and 160 can be rotated (inclined) around the axis perpendicular to the optical axis by the drivers 140a and 160a and can correct the slopes of the image plane of the secondary imaging optical system.

Since the sample 4c of the prepared slide 10c has a slope, the object distance from the primary imaging optical system 20 to the sample 4c is different according to locations. Therefore, the spherical aberration occurs which is different according to observation locations of the sample 4c in the initial state, and the imaging performance deteriorates. Accordingly, similar to the first embodiment, the spherical aberrations of the images formed on the image sensors 140 and 160 are corrected by moving the lenses 131, 133, 151, and 153 in the optical axis direction. In addition, the defocus position is also corrected by moving the image sensors 140 and 160 in the optical axis direction.

Since the cover glass 3c inclines relative to the optical axis of the primary imaging optical system 20 when the sample 4c is inclined, the coma and astigmatism occur at the field center (on the optical axis) in the images formed on the image sensors 140 and 160. Accordingly, the lenses 132 and 152 are moved in the direction perpendicular to the optical axis so as to correct the coma, and the plane-parallel plates 134 and 154 are inclined around the axis perpendicular to the optical axis so as to correct the axial astigmatism. The image slope is corrected by inclining the image sensors 140 and 160 around the axis perpendicular to the optical axis in accordance with the image slope near the image sensors 140 and 160.

This embodiment can capture an image with a good imaging performance in a wide field of view and with a small configuration.

### Fourth Embodiment

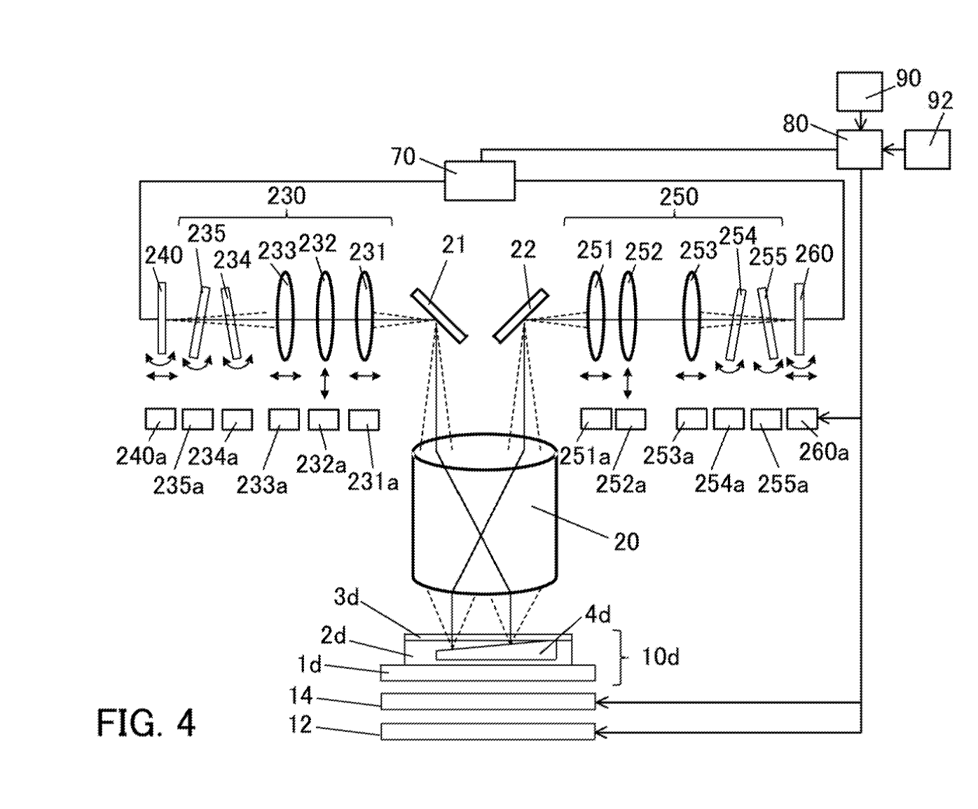

FIG. 4 is a block diagram of a microscopic system according to a fourth embodiment. Those elements in FIG. 4, which are corresponding elements in FIG. 1, are designated by the same reference numerals. The configuration of the microscopic system of FIG. 4 is the same as that of the microscopic system of FIG. 1 except for the prepared slide, the secondary imaging optical system, and the image sensor.

Reference numerals 230 and 250 denote secondary imaging optical systems, reference numerals 231 to 233 and 251 to 253 denote lenses, reference numerals 234, 235, 254, and 255 denote plane-parallel plates, and reference numerals 240 and 260 denote image sensors arranged at or near the image plane positions of the secondary imaging optical systems 230 and 250. Reference numeral 1d denotes a slide glass, reference numeral 2d denotes a filler, reference numeral 3d denotes a cover glass, and reference numeral 4d denotes a sample. The slide glass 1d to the sample 4d constitute the prepared slide (sample) 10d.

The prepared slide 10d is arranged at or near the object plane position of the primary imaging optical system. Since the thickness of the sample 4d scatters in a slope shape according to locations, as illustrated in FIG. 4, the filler 2d is inserted into a space between the cover glass 3d and the sample 4d, forming a wedge shape.

The second imaging optical system 230 is arrange on the left side of the mirror 21, and the left side of the image formed by the primary imaging optical system 20 is re-formed on the image sensor 240. The second imaging optical system 250 is arrange on the right side of the mirror 22, and the right side of the image formed by the primary imaging optical system 20 is re-formed on the image sensor 260.

The lenses (first lenses) 231, 233, 251 and 253 are configured to move in the optical axis direction of the image-pickup optical system by the drivers 231a, 233a, 251a, and 253a and to change the spherical aberrations. The lenses (second lenses) 232 and 252 are configured to move in the direction perpendicular to the optical axis by the drivers 232a and 252a, and can change a coma on the field center (on the optical axis) of the secondary imaging optical systems 230 and 250. Similar to the plane-parallel plates 134 and 154, the plane-parallel plates 234, 235, 254, and 255 are configured to rotate or incline around an axis perpendicular to the optical axis by the drivers 234a, 235a, 254a, and 255a and thereby can change astigmatism on the field center (on the optical axis) of the secondary imaging optical systems 230 and 250.

The image sensors 240 and 260 are configured to move in the optical axis direction by the drivers 240a and 260a, and can correct defocus positions. The image sensors 240 and 260 can be rotated (inclined) around the axis perpendicular to the optical axis by the drivers 240a and 260a and can correct the slopes of the image plane of the secondary imaging optical systems.

Since the sample 4d of the prepared slide 10d has a slope, the optical path from the primary imaging optical system 20 to the sample 4d is different according to locations. Therefore, the spherical aberration occurs which is different according to observation locations of the sample 4d in the initial state, and the imaging performance deteriorates. Accordingly, similar to the third embodiment, the spherical aberrations of the images formed by the image sensors 240 and 260 are corrected by moving the lenses 231, 233, 251, and 253 in the optical axis direction. In addition, the defocus position is also corrected by moving the image sensors 240 and 260 in the optical axis direction.

Since the filler 2d is inserted into a space between the cover glass 3d and the sample 4d due to the slope of the sample 4d, the wedge shape is formed. Thereby, the coma and astigmatism occur at the field center (on the optical axis) in the images formed on the image sensors 240 and 260. Accordingly, the lenses 232 and 252 are moved in the direction perpendicular to the optical axis so as to correct the coma on the optical axis, and the plane-parallel plates 234, 235, 254, and 255 are inclined around the axis perpendicular to the optical axis so as to correct the axial astigmatism. The image slope is corrected by inclining the image sensors 240 and 260 around the axis perpendicular to the optical axis in accordance with the image slope near the image sensors 240 and 260.

This embodiment can capture an image with a good imaging performance in a wide field of view and with a small configuration.

### Fifth Embodiment

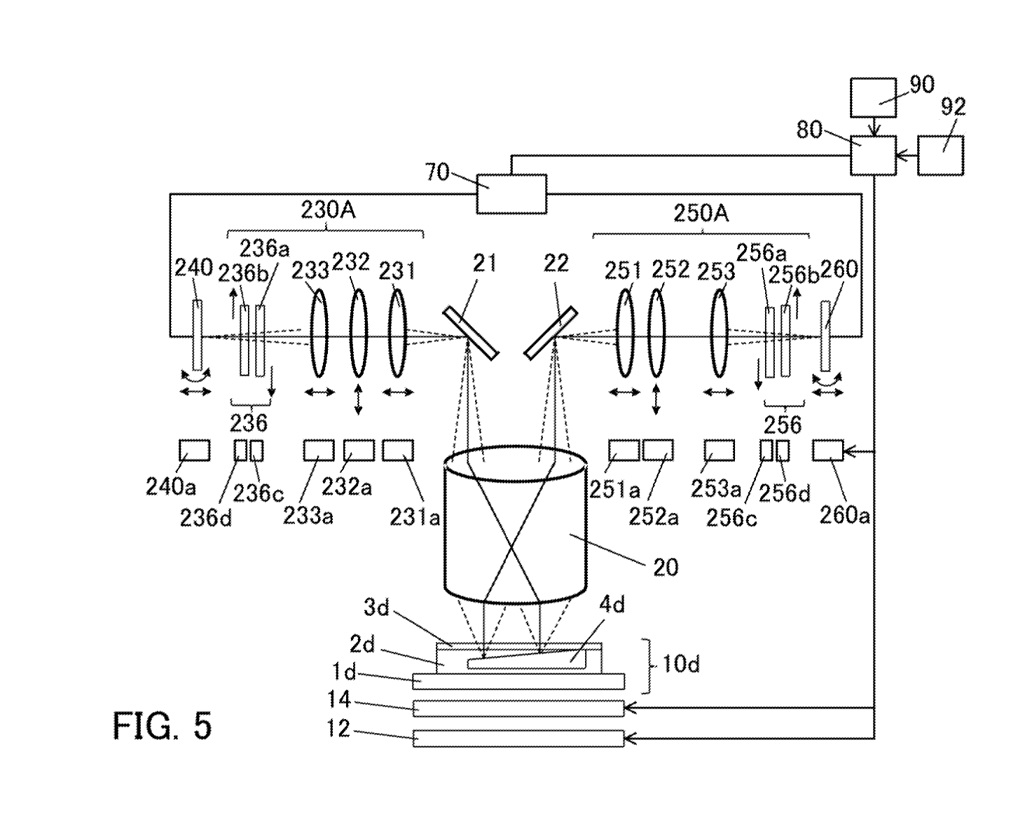

FIG. 5 is a block diagram of a microscopic system according to a fifth embodiment. Those elements in FIG. 5, which are corresponding elements in FIG. 4, are designated by the same reference numerals. The configuration of the microscopic system of FIG. 5 is the same as that of the microscopic system of FIG. 4 except for using an Alvarez lens 236 instead of the plane-parallel plates 234 and 235 and using an Alvarez lens 256 instead of the plane-parallel plates 254 and 255.

The Alvarez lens 236 includes a pair of optical elements 236a and 236b, and the two optical elements 236a and 236b are configured to move by equal amounts in reverse directions perpendicular to the optical axis by drivers 236c and 236d. Thereby, the astigmatism can be changed at the field center (on the optical axis) of the secondary imaging optical system 230A. Similarly, the Alvarez lens 256 includes a pair of optical elements 256a and 256b, and the two optical elements 256a and 256b are configured to move by equal amounts in reverse directions perpendicular to the optical axis by drivers 256c and 256d. Thereby, the astigmatism can be changed at the field center (on the optical axis) of the secondary imaging optical system 250A. Although the Alvarez lenses 236 and 256 have the same effects of the plane-parallel plates 234, 235, 254, and 255, the configuration becomes smaller in the optical axis direction.

According to this embodiment, the image can be captured with good imaging performance in a wide field of view and with a small configuration.

The present invention is applicable to the field of the microscopic system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-190612, filed Aug. 30, 2012 which is hereby incorporated by reference herein in its entirety.

What is claimed is:

1. An image-pickup optical system comprising:
a primary imaging optical system configured to form an image of an object;
a secondary imaging optical system configured to re-form an image of the object; and
a driver configured to drive an optical element included in the secondary imaging optical system and to change an aberration.

2. The image-pickup optical system according to claim 1, wherein the primary imaging optical system is an enlarged system.

3. The image-pickup optical system according to claim 1, further comprising an optical path deflector arranged near an image plane of the primary imaging optical system and configured to deflect an optical path.

4. The image-pickup optical system according to claim 1, wherein there are a plurality of secondary imaging optical systems each configured to re-form a different area of the image.

5. The image-pickup optical system according to claim 1, wherein the optical element includes a first lens, the driver drives the first lens in an optical axis direction of the image-pickup optical system.

6. The image-pickup optical system according to claim 1, wherein the optical element includes a second lens, the driver drives the second lens in a direction perpendicular to an optical axis of the image-pickup optical system.

7. The image-pickup optical system according to claim 1, wherein the optical element includes a plane-parallel plate, and the driver inclines the plane-parallel plate around an axis perpendicular to the optical axis of the image-pickup optical system.

8. The image-pickup optical system according to claim 1, wherein the optical element includes an Alvarez lens, and the driver moves two optical elements of the Alvarez lens in reverse directions perpendicular to an optical axis of the image-pickup optical system.

9. An image-pickup apparatus comprising:
an image-pickup optical system that includes a primary imaging optical system configured to form an image of an object, a secondary imaging optical system configured to re-form an image of the object, and a driver configured to drive an optical element included in the secondary imaging optical system and to change an aberration; and
an image sensor configured to photoelectrically convert the image of the object re-formed by the secondary imaging optical system.

10. The image-pickup apparatus according to claim 9, wherein the driver moves the image sensor in an optical axis direction of the image-pickup optical system.

11. The image-pickup apparatus according to claim 9, wherein the driver inclines the image sensor around an axis perpendicular to an optical axis direction of the image-pickup optical system.

12. The image-pickup apparatus according to claim 9, further comprising a controller configured to determine a driving amount of the driver.

13. An image-pickup system comprising:
an image-pickup apparatus that includes an image-pickup optical system, the image-pickup optical system including a primary imaging optical system configured to form an image of an object, a secondary imaging optical system configured to re-form an image of the object, and a driver configured to drive an optical element included in the secondary imaging optical system and to change an aberration, and an image sensor configured to photoelectrically convert the image of the object re-formed by the secondary imaging optical system;
a measurement unit configured to measure a surface shape of an object; and
a controller configured to determine a driving amount of the driver based upon a measurement result of the measurement unit.
